(19) United States
(12) Patent Application Publication
(10) Pub. No.: US 2018/0238283 A1
(43) Pub. Date: Aug. 23, 2018

(54) SYSTEMS AND METHODS ASSOCIATED WITH A UNIFIED DOUBLE VALVE SPRING SEAT AND VALVE SEAT

(71) Applicant: Jason Mangum, Georgetown, TX (US)

(72) Inventor: Jason Mangum, Georgetown, TX (US)

(21) Appl. No.: 15/900,364

(22) Filed: Feb. 20, 2018

Related U.S. Application Data
(60) Provisional application No. 62/461,625, filed on Feb. 21, 2017.

(51) Int. Cl. F02M 61/12

(52) U.S. Cl. CPC F02M 61/12

(57) ABSTRACT

Examples of the present disclosure are related to systems and methods associated with a double valve spring seat and valve seat formed of a single piece. More particularly, embodiments may be a double spring seat and valve seal that is configured to be utilized as a both a located for an inner spring on a double spring, as well as a seal assembly for a valve guide.

### CROSS-REFERENCE TO RELATED APPLICATIONS

This application claims a benefit of priority under 35 U.S.C. § 119 to Provisional Application No. 62/461,625 filed on 21 Feb. 2017, which is fully incorporated herein by reference in its entirety.

### BACKGROUND INFORMATION

### Field of the Disclosure

Examples of the present disclosure are related to assemblies, systems and methods associated with a double valve spring seat and valve seal formed of a single piece. More particularly, embodiments describe a double spring seat and valve seal that is configured to be utilized as a both a located for an inner spring on a double spring and a seal assembly for a valve guide. Embodiments may be configured to provide a mounting surface for both the inner and outer springs on the double spring.

### Background

Conventionally, valve guides and valve springs are utilized to locate a valve, so the valve makes proper contact with a valve seat. A valve guide is a cylindrical piece of metal, pressed or integrally cast into a cylinder head, with the valve reciprocating inside it. Clearance between an inner diameter of the valve guide and the outer diameter of a stem is critical for the proper performance of an engine. If there is too little clearance, the valve may stick as oil containments and thermal expansion may become factors. Alternatively, if there is too much clearance, the valve may not seat property and excessive oil consumption can occur.

Currently, when installing double valve springs associated with a valve guide, an installer must first position a discrete valve spring seat and then a discrete and separate valve seal. This not only takes additional time, but it can create a misalignment between the valve spring seat and the valve seal. Furthermore, this conventional method does not assist in holding the valve seal in place.

Accordingly, needs exist for more effective and efficient systems and methods a unitary part that is configured to locate the inner most valve spring of a double spring, provide a surface for mounting both inner and outer springs, and hold and secure the valve seal in place.

### SUMMARY

Embodiments disclosed herein describe systems and methods for a valve spring seat and valve seal comprised of a unitary piece, wherein the unitary piece includes a locator for an inner spring of a double spring. Embodiments may be configured for the unitary piece to locate the inner most spring as well as hold the valve seal in place. Due to the nature of the unitary piece, potential incorrect installations, misalignments, and seal movements may be reduced.

The unitary piece may include a spring seat, a locator, a first step, an outer sidewall, a valve seal, and a second step.

The spring seat may be positioned on a distal end of the unitary piece, and may be configured to be positioned adjacent to ends of an inner and outer spring, which form a double spring. The valve seat may also be configured to support the inner and outer spring, such that the inner and outer spring sit on the valve seat. The valve seat assembly may have a diameter that is at least wide enough to support both an inner and outer spring, wherein the diameter of the valve seat may be the widest diameter of the unitary piece.

The locator may be positioned adjacent to the valve seat and the first step. The locator may have an outer diameter that is slightly wider than an inner diameter of the inner spring, such that at least one turn of the inner spring may wrap around the locator. Therefore, the locator may be utilized to hold and second the inner spring in place. The locator may have a height that is at least as long as one revolution of a coil of the inner spring.

The first step may be a tapering, ledge, shelf, etc. that is configured to reduce the outer diameter of the unitary piece from the locator to the outer sidewall. Therefore, the outer sidewall may have a smaller diameter than that of the locator. The decreased diameter between the locator and the outer sidewall may allow the inner spring to be compressed and decompressed without interfacing with the outer sidewall, while still being secured in place via the locator. In embodiments, the first step may be positioned between the locator and the valve seal, wherein a heights of the outer sidewall and locator may vary based on the requirements of the system.

The valve seal may be positioned on a proximal end of the outer sidewall. The valve seal may be annulus with an outer diameter that is substantially the same as that of outer sidewall and an inner diameter that is substantially the same as second step. The valve seal may be comprised of rubber, such that a retainer doesn't directly contact the unitary piece, wherein the rubber may wrap around the upper edges of the outer sidewall. The valve seal may increase the upper diameter of the outer sider wall.

The second step may be configured to be a guide valve for a stem positioned through the unitary piece.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a unitary double spring valve seat and valve seal, according to an embodiment.

FIG. 2 depicts a unitary double spring valve seat and valve seal, according to an embodiment.

FIG. 3 depicts a unitary double spring valve seat and valve seal, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein describe systems and methods for a valve spring seat and valve seal comprised of a unitary piece, wherein the unitary piece includes a locator for an inner spring on a double spring.

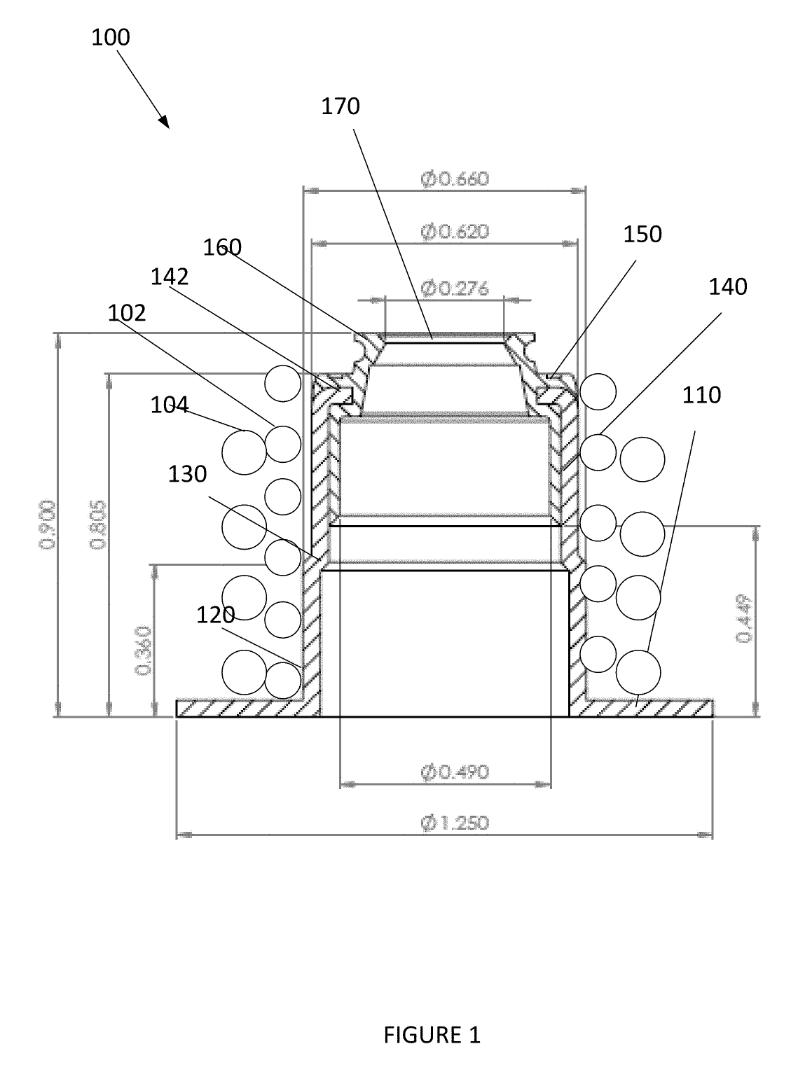

FIG. 1 depicts a unitary double spring valve seat and valve seal 100 (referred to hereinafter as “unitary piece”). Unitary piece 100 may include a spring seat 110, locator 120, first step 130, outer sidewall 140, valve seal 150, second step 160, and channel 170. In embodiments, unitary piece 100 may be comprised of metal, except for valve seal 150 which may be comprised of a rubber layer.

Spring seat 110 may be positioned on a distal end of unitary piece 100. Spring seat 110 may be a ledge, shelf, disk shaped projection, etc. that has a diameter between 1.23-1.32 inches. The diameter of spring seat 110 may be large enough to support an inner spring 102 and outer spring 104 associated a double spring. Spring seat 110 may have a planar upper surface, such that ends of the inner and outer spring may rest upon spring seat 110. In embodiments, spring seat 110 may have the largest diameter of any portion of unitary piece 100, such that the double spring may rest and sit of spring seat 110.

Locator 120 may have a first end positioned adjacent to spring seat 110 and a second end positioned adjacent to or at first step 130. Locator 120 may have an outer diameter that is slightly smaller to that of an inner diameter of an inner spring 102, such that the inner spring may wrap around locator 120 when compressed and be positioned adjacent to locator 120 when extended. In embodiments, inner spring 102 may be positioned directly adjacent to locator 120 or have a slight clearance, such as 0.01″ from locator 120. Responsive to compressing inner spring 102, the inner diameter of inner spring 102 may increase. This expansion may allow inner spring 102 to wrap around locator 120. Responsive to expanding the inner diameter of inner spring 102, inner spring 102 may be fixed around locator 120. Locator 120 may have sidewalls that are parallel to a longitudinal axis of unitary piece, such that an inner diameter of the smaller spring may be positioned adjacent to locator 120. Locator 120 may have a height of around 0.295″ and a diameter of 0.63-0.68″, which may be slightly more than half of the diameter of spring seat 110. The height of locator 120 may be substantially similar to at least one revolution of the coil of the inner spring 102, which may allow locator 120 to be secured in place within the inner spring.

First step 130 may be a tapered or planar shelf that is configured to reduce the outer diameter of unitary piece from locator 120 to outer sidewall 140. First step 130 may be tapered to distribute compression forces applied to unitary piece 100 from the valve or the springs. First step 130 may be utilized to decrease a diameter between locator 120 and outer sidewall 140, such that the inner spring is not positioned directly adjacent to outer sidewall 140. In embodiments, the height of first step 130 may be greater than or less than that of locator 120, wherein the height of first step 130 may be greater than that of locator 120 when first step 130 is tapered.

Outer sidewall 140 may extend from a proximal end of first step 130 to valve seal 150. Outer sidewall 140 may have a diameter that is less than that of locator 120, such that the inner spring does not contact outer sidewall 140. For example, outer sidewall 140 may have a diameter of 0.620″. This may allow the spring to be compressed and decompressed without interacting with outer sidewall 140. Outer sidewall 140 may include a lip 142 that extends towards the inner annulus of system 100. Lip 142 may be utilized to receive valve seal 150 to hold valve seal 150 in place.

Valve seal 150 may be positioned on a proximal end of outer sidewall 140, and may be configured to prevent oil leakage from a valve. Valve seal 150 may be an annulus, disk shaped, etc., wherein an outer diameter of valve seal 150 is substantially the same as that of outer sidewall 140 and an inner diameter that begins at second step 160. For example, an outer diameter of valve seal 150 may be 0.620″ and an inner diameter of valve seal may be approx. 0.492″ as to properly grip onto a 0.500″ diameter valve guide. An upper surface of valve seal 150 may be comprised of crushed rubber, such that the metal associated with a retainer does not directly contact the metal portions of unitary piece 100. The rubber may be configured to wrap around valve seal 150.

The second step 160 may be configured may be a disk shaped ledge, shelf, etc. positioned on a proximal end of unitary piece 100. Second step 160 may be configured to adjust the vertical offset of the upper end of unitary piece from an upper surface of valve seal 150. In embodiments, second step 160 may have an upper, cylindrical opening that is configured to receive a valve guide. Second step 160 may have a height such that the valve guide protrudes out of the head of second step 160.

Channel 170 may be a hollow passageway that is configured to extend from a proximal end of unitary piece 100 to a distal end of unitary piece 100. Channel 170 may be configured to receive a valve, such that the valve extends through and protrudes away from second step 150. Channel 170 would have a diameter of slightly less than 0.300′ diameter in order to properly seal against a larger valve.

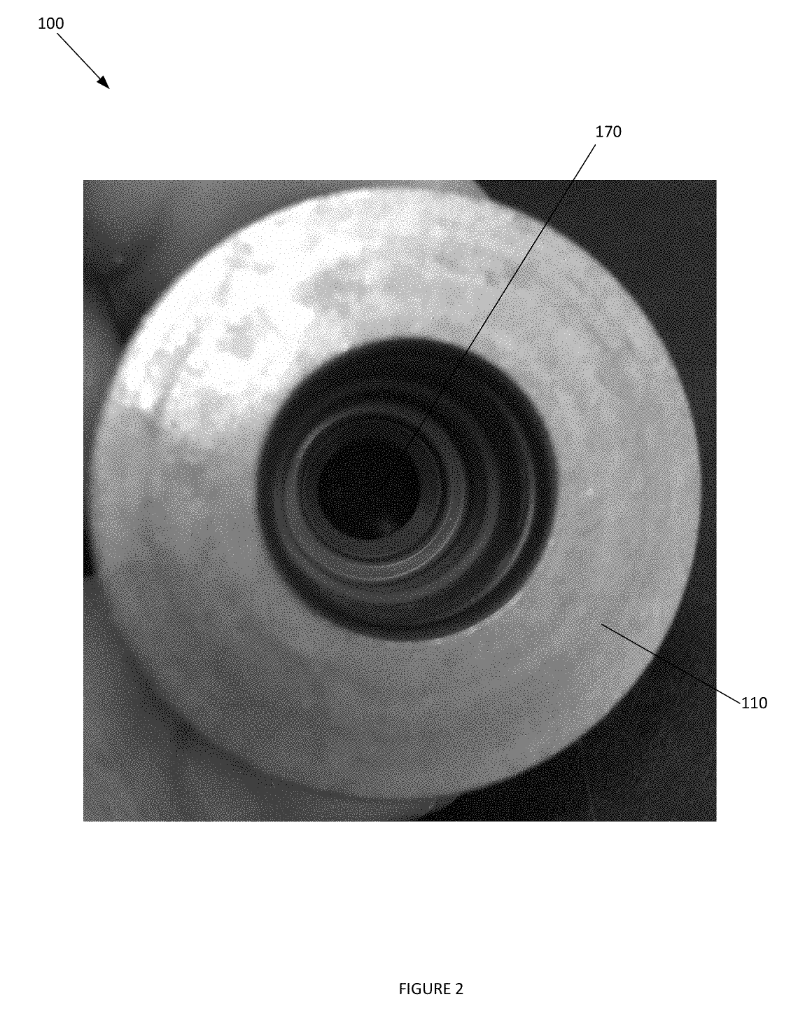

FIG. 2 depicts a bottom view of unitary piece 100, according to an embodiment, as depicted in FIG. 2, hollow chamber 170 may extend through the body of unitary piece 100, such that the valve guide may be positioned through the unitary piece allowing the valve to protrude through the upper most opening of chamber 170. Internally the valve guide seal has a step that locates around the 0.500″ valve guide. This 0.500″ valve guide has proper clearance for a slightly less than 0.3145″ valve to slide through the guide and ultimately be sealed by 170.

Furthermore, as shown in FIG. 2, the base of spring seat 110 may extend past locator 120, such that the locator 120 is integrally formed with spring seat 110. This may allow unitary device 100 to more equally distribute received forces.

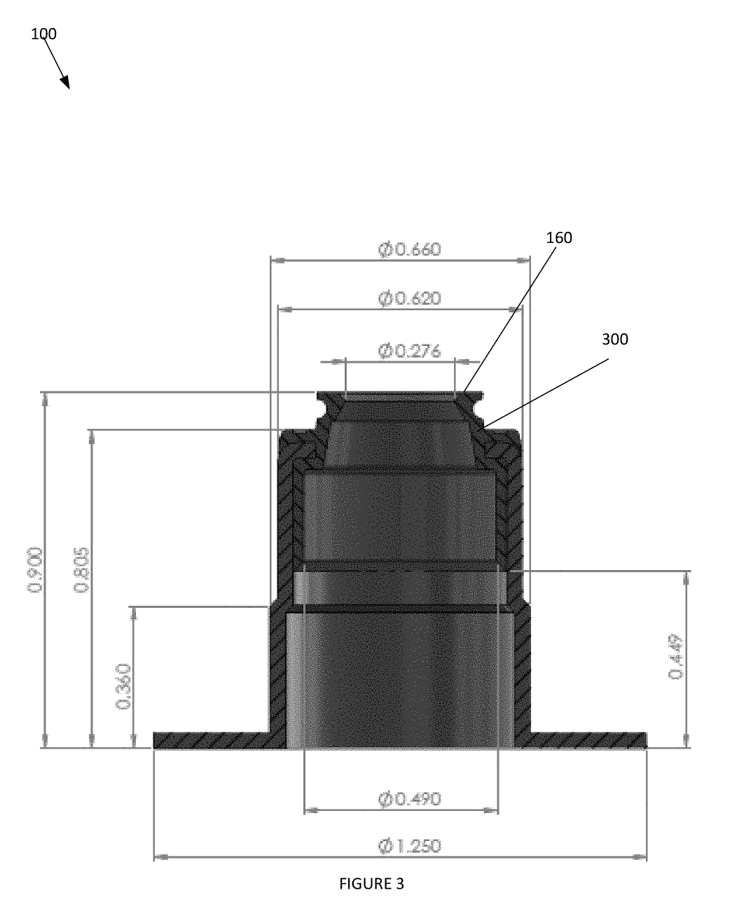

FIG. 3 depicts a perspective view of unitary piece 100, according to an embodiment.

As depicted in FIG. 3, a proximal end of unitary piece 100 may be covered by a compressed rubber layer 300. The compressed rubber layer 300 may be configured to wrap around and upper edge of a planar and linear sidewall of outer sidewall 140. The compressed rubber 300 may enable a retainer to directly interact with unitary piece 100 without having metal on metal contact. The compressed rubber 300 is configured to compress to allow the proximal end of unitary piece 100 to conform to the valve stem. In other words, once the valve stem is inserted into the channel 170, the sidewalls of the valve stem may compressed the compressed rubber 300, such that the sidewalls of the valve stem are directly adjacent to compressed rubber 300.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. A unified double valve spring seat and valve seat comprising:
a spring seat positioned on a proximal end of the unified double valve spring seat and valve seat, the spring seat having a first diameter, the spring seat configured to secure first ends of an inner spring and an outer spring in place, wherein the inner spring and the outer spring form a double spring;
a locator having a second diameter and first height, the second diameter being less than the first diameter, the first height being at least as tall as one revolution of the inner spring, and the locator being positioned adjacent to the spring seat and having a smooth planar surface, and the locator being positioned to adjacent to the inner spring;
a first step configured to decrease the second diameter of the locator to a third diameter, wherein the first step is tapered at an upward angle on an angled plane;
an outer sidewall having the third diameter, the outer sidewall extending from the first step towards a distal end of the unified double valve spring seat and valve seat, wherein the spring seat, the locator, the first step, and the outer sidewall are all inseparable, wherein a second height of the outer sidewall is greater than the first height of the locator.

2. The unified double valve spring seat and valve seat of claim 1, further comprising:
a valve seal positioned adjacent to the outer sidewall.

3. The unified double valve spring seat and valve seat of claim 1, wherein the first diameter is between 1.23 and 1.32 inches.

4. The unified double valve spring seat and valve seat of claim 1, wherein the first height is approximately 0.295 inches.

5. The unified double valve spring seat and valve seat of claim 1, wherein the first step is tapered to distribute compression forces.

6. The unified double valve spring seat and valve seat of claim 1, further comprising:
a channel extending from the proximal end to the distal end of the unified double valve spring seat and valve seat, the channel having varying diameters from the proximal end to the distal end.

7. The unified double valve spring seat and valve seat of claim 1, wherein the outer spring is not positioned adjacent to the locator.
